(19) United States
(12) Patent Application Publication
(10) Pub. No.: US 2015/0161112 A1
(43) Pub. Date: Jun. 11, 2015

(54) ONE CLICK LOCALIZATION TECHNIQUES

(71) Applicants: Michael Galvez, Sparta, NJ (US); Jeffrey Jar-hou Chin, Medina, WA (US)

(72) Inventors: Michael Galvez, Sparta, NJ (US); Jeffrey Jar-hou Chin, Medina, WA (US)

(73) Assignee: GOOGLE INC., Mountain View, CA (US)

(21) Appl. No.: 13/446,449

(22) Filed: Apr. 13, 2012

(51) Int. Cl. G06Q 10/06; G06F 17/28; G06F 17/30

(52) U.S. Cl. CPC G06F 17/289; G06F 17/3053; G06F 17/30569

(57) ABSTRACT

A technique includes receiving a translation request from a requestor device at a service provider network. The translation request includes translatable content. The translatable content is normalized to provide formatted words that are in a predetermined format. A number of words to be translated, a cost to translate the formatted words, and an amount of time for the formatted words to be translated are estimated. A group of the translators that are available and capable of translating the formatted words is determined. A response signal is transmitted to the requestor device and indicates the number of words, the cost, and the amount of time. A translation of the formatted words is initiated based on an accept signal received from the requestor device indicating a selected translator. The formatted words to be translated are routed to the selected translator. Results of the translation are received and routed to the requestor device.

### FIELD

The present disclosure relates to localization of translation techniques.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A service provider that provides translation services can receive requests to translate various types of content between two or more native languages, that is, perform one or more interlingual translations. The content received by the service provider may be translatable or non-translatable, based on whether the file type and/or format of the content are recognizable to the service provider and/or a translator.

The file types of the content may include, for example, code, text, presentations and images, each of which may have different file formats. The file formats may include formats for text, images, presentations, web pages, web browsers, programming languages, and scripting languages (e.g., Javascript). The file formats may also include service provider specific formats, or other user interface (UI) file formats. Some example file format extensions are .txt, .gxp, .html, .xml, and .ppt.

The requests to translate content may be generated by various different user (or requestor) devices internal to a service provider network or external from the service provider network. As an example, the requests may be received from engineers and/or non-engineers of a service provider and/or from customers of the service provider.

### SUMMARY

A computer-implemented technique is provided and includes receiving a translation request from a requestor device at a service provider network that includes one or more computing devices configured to perform translation services. The translation request includes a file with translatable content. A type and a format of content in the file including the translatable content are determined at the service provider network. The file is transferred to a preview module. At least one file handling module from multiple file handling modules of the service provider network is selected to normalize the translatable content based on the type and the format and prior to sending the content of the file to the at least one file handling module. The translatable content is normalized via the selected file handling module to provide formatted words that are in a predetermined format recognizable to each of multiple translators. At a translator managing module of the service provider network, a number of formatted words to be translated and characteristics of each of the translators are estimated based on the formatted words. The estimated characteristics include: (i) a cost to translate the formatted words, and (ii) an amount of time for the formatted words to be translated.

The technique further includes determining, at the translator managing module, a group of the translators that are available and capable of translating the formatted words based on the estimated characteristics. A response signal is transmitted from the service provider network to the requestor device. The response signal indicates the number of formatted words to be translated, the estimated characteristics and the group of the translators. A translation of the words is initiated via the service provider network based on an accept signal received from the requestor device indicating a selected translator. The formatted words to be translated are assigned and routed to the selected translator. Results of the translation are received from the selected translator at a work flow fulfillment module of the service provider network. The results are routed from the work flow fulfillment module to the requestor device.

In other features, a computer-implemented technique is provided and includes receiving a translation request from a requestor device at a service provider network that includes one or more computing devices configured to perform translation services. The translation request includes a file with translatable content. The translatable content is normalized through at least one file handling module of the service provider network, to provide translatable words that are in a predetermined format. At a translator managing module of the service provider network, a number of formatted words to be translated and characteristics of each of multiple translators are matched. The characteristics include: (i) a cost to translate the formatted words, (ii) an amount of time for the formatted words to be translated, and (iii) the availability of the translator.

The technique further includes determining, at the translator managing module, a first group of the translators that are available and capable of translating the formatted words based on the characteristics. A response signal is transmitted from the service provider network to the requestor device. The response signal indicates the number of formatted words to be translated, the characteristics and the group of the translators. One of the first group of the translators that are available and capable of translating the formatted words is selected. A translation of the formatted words is initiated via the service provider network at the selected translator. The formatted words to be translated are assigned and routed to the selected translator via a work flow fulfillment module of the service provider network. Results of the translation are received from the selected translator at the work flow fulfillment module. The results are routed from the work flow fulfillment module to the requestor device.

In other features, a technique is provided and includes a service provider network. The service provider network includes one or more computing devices configured to perform translation services. The service provider network is configured to receive a translation request from a requestor device. The translation request includes a file with translatable content. At least one file handling module of the service provider network is configured to normalize the translatable content to provide formatted words that are in a predetermined format. A translator managing module of the service provider network is configured to estimate a number of formatted words to be translated match the formatted words to be translated with the characteristics of each of multiple translators. The characteristics include: (i) a cost to translate the formatted words, (ii) an amount of time for the formatted words to be translated, and (iii) availabilities of one or more of the translators.

The technique further includes the translator managing module being configured to determine a first group of the translators that are available and capable of translating the formatted words. The service provider network is configured to transmit a response signal to the requestor device indicating the number of formatted words to be translated, the characteristics and the group of the translators. An accept module of the service provider network is configured to (i) select one of the first group of the translators that are available and capable of translating the formatted words, and (ii) initiate a translation of the words at the selected translator. A work flow fulfillment module of the service provider network is configured to assign and route the words to be translated to the selected translator and receive results of the translation from the selected translator. The service provider network routes the results to the requestor device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is a functional block diagram of an example environment for performing a translation technique in accordance with some embodiments of the present disclosure;

FIG. 2 is a functional block diagram of a portion of the environment of FIG. 1; and

FIG. 3 is a flow diagram illustrating an example technique of operating a translation network in accordance with some embodiments of the present disclosure.

### DESCRIPTION

A service provider that provides translation services receives translation requests from requestors. In order to fill a translation request, the service provider needs to arrange translation of received content with a translator. The translator may be within a network of the service provider (referred to as the service provider network or backend) or external to the service provider network. Networks external to the service provider network may be referred to as being part of a frontend. Each translator may be a machine translation network or system and/or a human-based translation company.

The translator may be selected from a database of numerous translators. This may be performed by a project manager (or liaison) that manually makes arrangements with a selected translator based on requirements provided by a requestor of the content to be translated. The requirements may include languages involved in the translation, costs of the translation, and speed of the translation (or wait time until translation is completed). Each translator has respective translation capabilities and associated translation speeds and costs per translation.

The project manager introduces wait time between when a translation request is generated and when a translation request is filled (or completed). In addition, engineers may be needed to convert the content to be translated into a format that is recognizable to a translator. This further increases wait time and costs associated with performing a translation.

Thus, there can be a significant amount of variability in: input files (translation requests and content) received; the translators used to perform the translations; and wait times associated with filling the translation requests. The variability in each step of the translation process creates a significant amount of back-and-forth discussions between the requestor, the project manager, and the translator. As a result, processing and handling of the requests can be technically and operationally complex and costly.

The implementations disclosed herein overcome the above-described drawbacks. The implementations provide localized translation request gathering, scheduling, and processing while minimizing variability and improving translation efficiency.

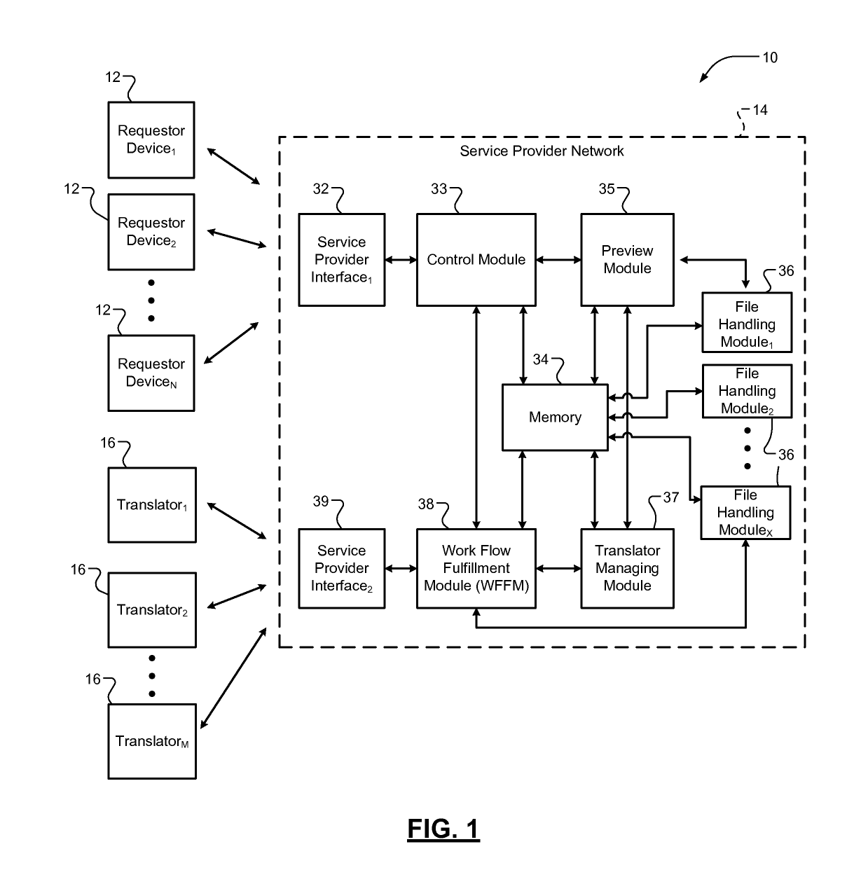

In FIG. 1, a translation network 10 is shown. The translation network 10 includes one or more requestor devices (or requestors) 12, a service provider network 14 and one or more translators (or translation editing modules) 16. As an example, N requestor devices and M translation editing modules are shown, where N and M are integers. The requestor devices 12 may be, for example, a server, a computer (e.g., laptop computer, desktop computer, mobile device, cellular phone, and a personal data assistant), or other suitable requestor network or device. The requestor devices 12 generate and transmit translation requests and corresponding data files to the service provider network 14. The service provider network 14 schedules and processes the translation requests via the translators 16. Each of the translation requests may include requests to perform one or more interlingual translations between two or more languages (language pair(s)) and a data file including data to be translated.

Although the requestor devices 12 are shown as being separate from the service provider network 14, it should be appreciated that the requestor device 12 may be part of a network of the service provider network 14 and/or be within the service provider network 14. The requestor device 12 may be used by an engineer or non-engineer of a service provider of the service provider network 14 or by a customer of the service provider.

The service provider network 14 includes a first service provider interface 32, one or more control modules (one control module 33 is shown), a memory 34, a preview module 35, file handling modules 36, a translator managing module 37, a work flow fulfillment module (WFFM) 38, and a second service provider interface 39. The first service provider interface 32 communicates with the requestor devices 12 and transfers the translation requests and corresponding data files to the control module 33. The control module 33 may store the data files and translation requests in the memory 34. The control module 33 and/or other modules of the service provider network 14 receive the data files, provide translation estimates to the requestor devices 12 based on content in the data files, and convert the content into a format recognized by one of the translators 16, the preview module 35, and/or the WFFM 38. The translation estimates may include, for example, a number of files to be translated, a number of words to be translated, a cost to perform a translation, and an estimate of time to perform the translations.

The memory 34 may be located within the control module 33 or one of the other modules of the service provider network (e.g., one of the modules 35, 36, 37, 38), or may be a standalone memory accessible by one or more of the modules of the service provider network 14. Also, one or more of the interfaces 32, 39 and/or one or more of the modules 33, 35, 36, 37, 38 may be incorporated into a single module or may be standalone interfaces and modules, as shown. In one implementation, the interfaces 32, 39 and the modules 33, 35, 36, 37, 38 are combined to form a single module having an associated single binary. An example of a binary is a software or firmware program that implements tasks of one or modules. When these interfaces 32, 39 and modules 33, 35, 36, 37, 38 are implemented as discrete interfaces and modules, the interfaces 32, 39 and modules 33, 35, 36, 37, 38 may generate respective remote-procedure-calls (RPCs) to perform various tasks disclosed herein. As an example the control module and/or the WFFM 38 may delegate tasks to be performed to other modules of the service provider network 14 by transmitting RPCs to the other modules. When these interfaces 32, 39 and modules 33, 35, 36, 37, 38 are combined to form a single module, RPCs may not be generated and/or passed to perform these tasks.

The preview module 35 may provide one or more of the translation estimates or other related parameters. The parameters may also include a list or table of qualified and available translators. The preview module 35 may determine the qualified and/or available translators and/or may transmit a RPC to the translator managing module 37 to perform this determination. The preview module 35 may estimate or determine one or more of the parameters and/or skip estimating or determining one or more of the parameters. For example, if a requestor device does not have a translator preference, the preview module 35 may not determine or generate the RPC to determine qualified translators available to perform the translation.

The preview module 35 may transmit parameters to the control module 33, which may in turn transmit the parameters back to the corresponding requestor device as a preview. This allows an operator of the requestor device to preview the parameters prior to approving performance of a translation. The requestor device may then update the parameters prior to approval. The parameters may include, for example, parameters associated with translation estimates, the number of words to be translated, languages associated with the translation, time to perform the translation, a maximum fee that a user of the requestor device is willing to pay for the translation, preferred translators, and/or other related parameters disclosed herein.

The file handling modules 36 normalize the data files. The file handling modules 36 may be dedicated to normalizing files of a certain type or may be capable of normalizing files of different types. The data files or content of a translation request may be normalized into a predetermined format that is recognizable to one or more of the translators 16. This is described in further detail below. The normalized content generated by the file handling modules 36 may be stored in the memory 34.

The translator managing module 37 determines which ones of the translators 16 are qualified and available to perform requested translation(s). The translator managing module 37 may find the translators that best satisfy constraints provided by the control module 33 and/or received by the requestor devices 12. Identifiers and/or addresses of qualified and available translators may be stored in the memory 34. As an example, if a translation request from one of the requestor devices 12 or other request from the control module 33 indicates performing a translation from a first language (e.g., English) to a second language (e.g., French), then the translator managing module 37 determines which of the translators 16 are capable of performing this type of translation. As another example, if the translation request or request from the control module 33 indicates translating a certain number of words (e.g., 20,000 words) by a certain date, the translator managing module 37 determines which of the translators 16 are capable of translating a portion or all of the words by the requested date.

The WFFM 38 assigns translations or portions thereof to selected one(s) of the translators 16, routes files to be translated from the control module 33, the memory 34, and/or the file handling modules 36 to the translators 16 via the second service provider interface 39. The WFFM 38 also routes translated files from the selected one(s) of the translators 16 back to the service provider network 14, the control module 33, the memory 34, and/or the appropriate ones of the requestor devices 12. Although the service provider interfaces 32, 39 are shown as separate entities, the service provider interfaces 32, 39 may be integrated into a single interface and/or module of the service provider network 14.

One or more of the interfaces 32, 39, the memory 34, and/or the modules 33, 35, 36, 37, 38 may be separate interfaces, modules, computers, and/or servers or be combined into one or more interfaces, modules, computers, and/or servers. In one implementation, the interfaces 32, 39, the memory 34, and/or the modules 33, 35, 36, 37, 38 are discrete servers or are each included in a respective server.

The translators 16 translate content received by the WFFM 38 via the second service provider interface 39. The translators 16 may each be, for example, a module, a computer, and/or a server. Each of the translators 16 may be dedicated to translating certain content (or data) of one or more file types and/or file formats. One or more of the translators 16 may be part of the service provider network 14. The translators 16 may be associated with a respective translator service companies and/or vendors contacted by the service provider network 14. Although the translators 16 are shown as being external to the service provider network 14, one or more of the translators 16 may be included in the service provider network 14.

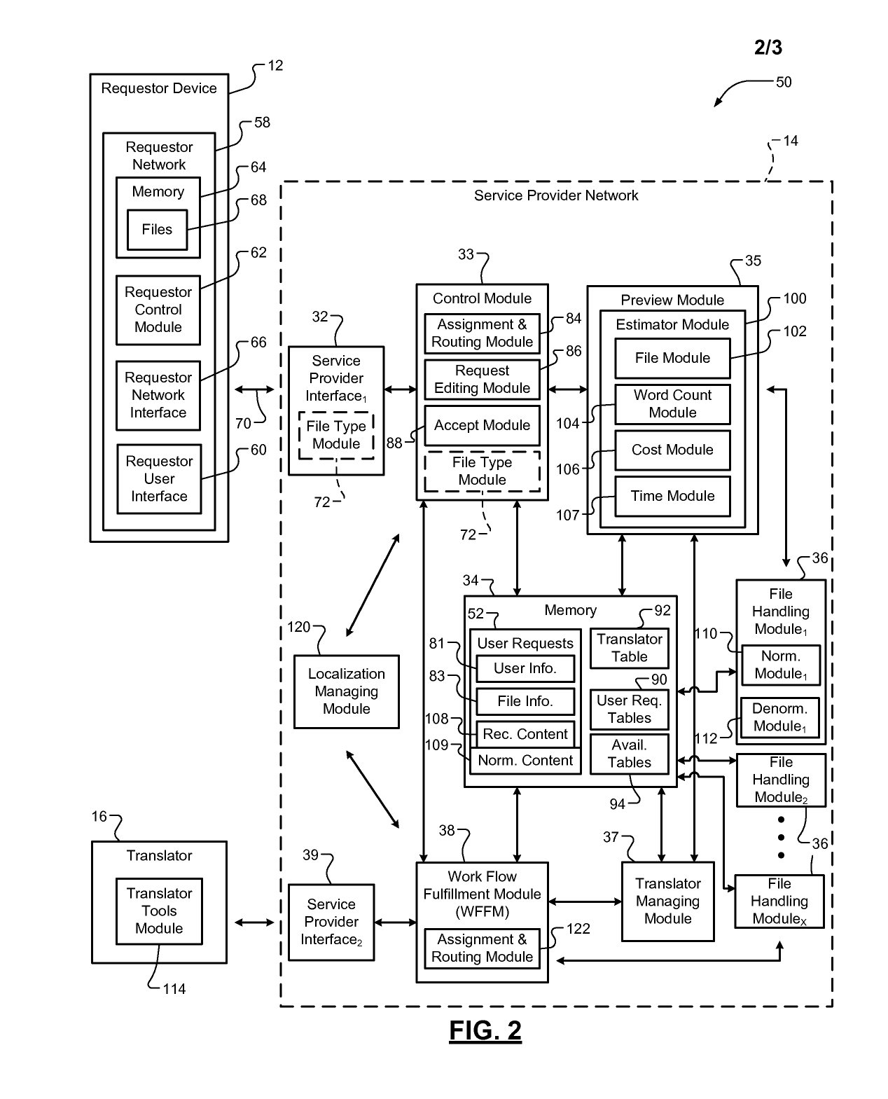

Referring now also to FIG. 2, a portion 50 of the translation network 10 is shown. The portion 50 includes one of the requestor devices 12, the service provider network 14 and one of the translators 16. The requestor device 12 generates and transmits translation requests (or user requests) 52 to the service provider network 14, which may be stored in the memory 34. The service provider network 14 schedules and processes the translation requests 52 via the translators 16. Each of the translation requests 52 may include requests to perform one or more interlingual translations between two or more languages.

The requestor device 12 includes a requestor network 58, a requestor user interface 60, a requestor control module 62, a memory 64 and a requestor network interface 66. The requestor user interface 60 may include a keyboard, a display, a touchscreen, a mouse, a touch pad and/or any other suitable user interface. The requestor control module 62 may include one or more integrated circuits and/or processors. The memory 64 may include non-volatile memory and store files 68 to be translated. Although the memory 64 is shown as part of the requestor network 58, the memory 64 may be separate from and accessed by the requestor network 58. The requestor network interface 66 may include a network interface card (NIC) and/or other wireless and/or wired communication devices for communicating with a network 70 between the requestor network 58 and the service provider network 14.

The service provider network 14 includes the first service provider interface 32, the control module 33, the memory 34, the preview module 35, the file handling modules 36, the translator managing module 37, the WFFM 38, and the second service provider interface 39. The first service provider interface 32 communicates with the requestor network interface 66. The service provider interface 32 or the control module 33 may include a file type module 72.

The file type module 72 determines file type(s) and/or file formats of files (or content) received from the requestor device 12. The file types may include, for example, code, text, presentations and images, each of which may have different file formats. The file formats may include formats for text, images, presentations, web pages, web browsers, programming languages, and scripting languages (e.g., Javascript). The file formats may also include service provider specific formats, proprietary formats, or other user interface (UI) file formats with UI strings. Some example file format extensions are .txt, .gxp, .html, .xml, and .ppt. The first service provider interface 32 and/or the file type module 72 may select one of the control module(s) 33 based on the file type and transfer the translation requests 52 and corresponding data files to the selected control module 33.

The first service provider interface 32 transfers translation requests and data files from the requestor device 12 to the control module 33. The control module 33 receives the translation requests 52 including the data file(s) from the requestor device 12 and may store the translation requests 52 in the memory 34 (e.g., non-volatile memory). Each of the translation requests 52 includes content to be translated and may also include user information 81 and file information 83. The file information 83 may include, for example, metadata and/or layout and formatting of translatable text. The metadata may include, for example, time when a file was created, name of a user who created the file, and name of a user who last edited the file.

The user information 81 may include security information (e.g., a user identifier (ID) and password) and a user address. The file information 83 may include a number of files transmitted, lengths of the files, and file type and/or format identifiers. The memory 34 may be located in the service provider network 14, one of the modules 35, 37, 38 or elsewhere and accessed by the modules 33, 35, 36, 37, 38. The data, content, information, and/or tables stored in the memory 34 may be updated by the modules 33, 35, 36, 37, 38.

The control module 33 provides the parameters including translation estimates received from the preview module 35 to the requestor device 12 based on the content received from the requestor device 12. The control module 33 may include an assignment and routing module 84, a request editing module 86 and/or an accept module 88. The assignment and routing module 84 may transfer data files to be translated to the preview module 35 to have the data files normalized and/or translation parameter estimates performed. The assignment and routing module 84 may also transmit translation requests to the WFFM 38 to have translation parameter estimates confirmed or updated and/or to have translations performed. Translations received back from the WFFM 38 may then be routed by the assignment and routing module 84 to the requestor device 12.

The request editing module 86 may be used to update user requirements transmitted from the requestor device 12 to the service provider network 14 and stored as user requirement tables 90 in the memory 34. The user requirement tables 90 may include user requirements associated with each requestor device including the requestor device 12. The user requirements may be provided once when a first translation for a requestor device is performed and used for subsequent translations or may be updated based on information received from the requestor device. The request editing module 86 may receive requirement requests from the requestor device 12 and update the appropriate one of the user requirement tables 90.

The user requirements may include translation cost requirements, translation time (or speed) requirements, preferred translator requirements, quality of translation requirements, translator ranking requirements, efficiency requirements, or other translation requirements, such as requirements associated with each translator characteristic. The characteristics of each of the translators 16 may include: file types and formats translatable by the translator; the languages that the translator is capable of translating between; efficiency, quality (or accuracy), reliability, and translation speed values of the translator; cost per word or page of translation; number of translations performed in the past for the requestor device 12 and/or for other requestor networks; a recommendation level of the translator; workload capacity of the translator; and a current workload (e.g., number of files currently being translated or to be translated by the translator). The translator expertise may identify an academic degree, an advanced degree, a postgraduate degree or other degree of a person performing the translation, such as, for example, a science degree or a medical degree.

The efficiency, quality, reliability, speed, and other values relevant to the translation and the recommendation level may be measured and/or generated by the translator managing module 37 and/or the WFFM 38 and stored in the memory 34. The efficiency values may account for average turnaround times of a translator. A translator may have associated delays that affect the overall turnaround time and the efficiency of a translator. For this reason, although two translators may be capable of performing a translation at the same speed, the overall turnaround times of the translators may be different. The recommendation level may be determined based on the characteristics of the translator.

The efficiency, quality, reliability, and speed values and the recommendation level may be used by the translator managing module 37 and/or the WFFM 38, some other module of the service provider network 14 and/or by the requestor device 12 to rank the translators. The translator managing module 37 and/or the WFFM 38 may provide an availability table identifying a best ranked translator as well as other translators available and capable of performing the translation request to the requestor device 12. The requestor control module 62 may display the availability table for review by a user. The user may select a translator based on the availability table.

The translator status and characteristics may be, for example, periodically updated and/or updated as status and/or characteristic information is provided by the translators 16. This maintains an updated status of each translator. The status and/or characteristics of each of the translators 16 may be updated in a translator table 92 and/or availability tables 94 stored in the memory 34. This may be performed by the translator managing module 37 and/or the WFFM 38. The translator table 92 may include a total list of possible translators (a first group of translators). Each of the availability tables 94 may include list of a subset of the translators (additional groups of translators) listed in the translator table 92.

The accept module 88 may be referred to as a “one-click” device and starts execution of a translation request based on an accept signal received from the requestor device 12 and/or based on when an available translator meets a requestor's request requirements. The accept signal may indicate that one or more of the translators that satisfy the requestor's requirements may be selected.

A requestor via a corresponding requestor device may indicate that any translator that satisfies the requestor's requirements may be selected. The accept module 88 may initiate execution of a translation request based on the accept signal and/or upon determining and/or being signaled by another module of the service provider network 14 that one or more translators satisfy the requestor's requirements. For example, one of the translation managing module 37 and the assignment and routing module 84 may determine that one or satisfy the requestor's requirements and the accept module 88 may then select one of the translators and initiate execution of the translation request.

The control module 33 or the WFFM 38 provides normalized content to the appropriate one(s) of the translators 16 when the user, the requestor device, and/or the accept module 88 accepts translation offer(s) by one or more of the qualified and available translators. The control module 33 or the accept module 88 may also provide user requirements to the WFFM 38. As an alternative, one or more of the tasks performed by the modules 33, 35, 36, 37, 88 may be performed by the WFFM 38.

The preview module 35 estimates and/or determines the parameters including the translation estimates, as described above. The preview module 35 includes an estimator module 100. The estimator module 100 includes a file count module 102, a word count module 104, a cost module 106, and a time module 107. The file count module 102 counts and/or determines the number of files to be translated. The word count module 104 counts and/or determines the number of words to be translated. The cost module 106 calculates cost to perform the translation for each available translator in the availability table to be provided to the requestor device 12. The time module 107 determines and/or estimates an amount of time to perform the translation(s) requested based on the speed and/or efficiency values of the available translators.

The file handling modules 36 normalize the data files or received content 108 of the translation requests to generate normalized content 109. The normalized content 109 generated by the file handling modules 36 may be stored in the memory 34. The file handling modules 36 each include a normalizing module 110 and a denormalizing module 112. The normalizing modules 110 normalize content of a translation request into a predetermined format that is recognizable to one or more of the WFFM 38, the translators 16 and/or the translator tools module(s) 114 of the translators 16. The denormalizing modules 112 denormalize translated content into a format recognizable by the requestor device 12.

The normalized content 109 may be stored in the memory 34. The normalized content 109 may be stored with the corresponding translation request and/or corresponding received content as a content pair. The control module 33, the preview module 35 and/or the normalizing modules 110 may separate content that is translatable from content that should not be translated (referred to as non-translatable content). Non-translatable content is not content that can't be converted into a recognizable format, but rather is content that should not be translated by a translator. Non-translatable content may be, for example, programming code, structural formatting and/or inline formatting. If non-translatable content was edited or translated, the returned translated file may be unusable (e.g., code in the returned file may not run, or text in the returned file may be formatted incorrectly).

As each of the file handling modules 36 may be specific to a particular file type and/or format, the normalizing modules 110 convert the particular file type and/or format to a common format recognizable by the translators 16, a translator tools module 114 of the translators 16, and/or the WFFM 38. For example, each of the normalizing modules 110 may convert a respective format to the HTML format, a service provider specific format, or other suitable format. Providing content in a single common recognizable format to the translators 16 aids in streamlining, simplifying and improving translation efficiency of a translation process. Normalizing to a single format may also minimize and/or eliminate back-and-forth discussions between a user and project managers and/or engineers when performing a translation.

The translator managing module 37 determines which ones of the translators 16 are qualified and available to perform requested translation(s). The translator managing module 37 and/or the WFFM 38 monitors a status and the characteristics of each of the translators 16. A status of a translator may indicate: whether the translator is connected to a network of the service provider network 14; and/or a current work load of the translator. The current work load may be provided in a workload report received from the translators 16 to the service provider network 14.

The translator managing module 37 and/or the WFFM 38 selects the translators to be listed in one of the availability tables 94 based on the status information, translator characteristics and user requirements. The availability tables 94 may be stored at the translator managing module 37, the WFFM 38, the translator tools module 114, in the memory 34 as shown, or in another suitable location. The translator managing module 37, the WFFM 38 and/or the translator tools module 114 may access the availability tables 94.

The availability tables 94 may be generated based on the user requirements, which may be stored as user requirement tables 90 in the memory 34. The translator managing module 37 and/or the WFFM 38 may select translators and generate an availability table for the requestor device 12 based on the user requirements provided by and/or stored for the requestor device 12.

If the translator managing module 37 and/or the WFFM 38 determines that: there is not any translatable content; there is not a translator available and/or capable of performing the translation; and/or the translation request cannot be routed and/or filled, the translator managing module 37 and/or the WFFM 38 may alert the control module 33 and/or the WFFM 38. One of the modules 33, 37, or 38 may then route the translation request or an alert signal to the requestor device 12 and/or to a localization managing device 120. The localization managing device 120 may in turn alert a project manager that a translation cannot be automatically processed. The project manager may then attempt to manually route the translation request and/or have the translation performed manually.

The WFFM 38 may include an assignment and routing module 122. The assignment and routing module 122 may assign translations to selected one(s) of the translators 16. The assignment and routing module 122 may also route files to be translated from the control module 33, the memory 34, and/or the file handling modules 36 to selected one(s) of the translators 16 via the second service provider interface 39. The assignment and routing module 122 also routes translated files from the selected one(s) of the translators 16 back to the service provider network 14, the control module 33, the memory 34, and/or the appropriate ones of the requestor devices 12.

The translators 16 translate content received by the WFFM 38 via the second service provider interface 39. The translators 16 may include and/or access a translator tools module 114 to perform the translations. The translator tools module 114 may provide conversions between words, terms, and/or phrases of different languages. The conversions may be performed based on file type and/or format. The translator tools module 114 may be located in one or more of the translators 16 or may be internal or external to the service provider network 14, as shown. The translator tools module 114 may be implemented in a server. The translator tools module 114 may be combined with one or more of the interfaces (e.g., the interfaces 32, 39) and/or modules (e.g., the modules 33, 38) of the server provider network 14.

The translation networks disclosed herein may be identified as translation systems. The requestor networks disclosed herein may be identified as requestor systems. The service provider networks disclosed herein may be identified as service provider systems.

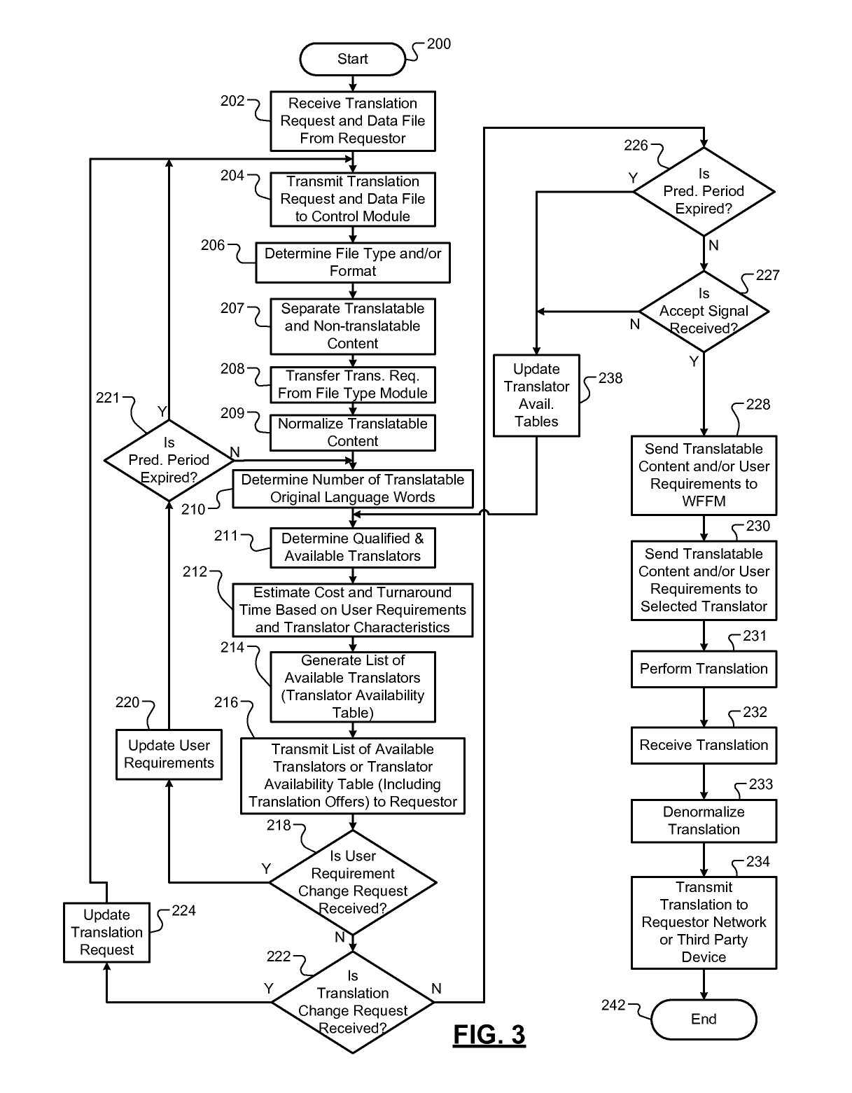

The above-described translation network 10 may be operated using numerous techniques, such as the example technique (or computer-implemented method) provided in FIG. 3. In FIG. 3, a translation operating technique for the translation network 10 and/or the service provider network 14 is shown. Although the following tasks are primarily described with respect to the implementations of FIGS. 1 and 2, the tasks may be easily modified to apply to other implementations of the present disclosure. The tasks may be iteratively performed. The technique may begin at 200.

At 202, the first service provider interface 32 receives a translation request including a data file from the requestor device 12. The translation request may include content to be translated and job request information, which may include user (or translation) requirements, the user information 81 and/or the file information 83. At 204, the translation request is transferred to the control module 33. At 206, the file type module determines type(s) and/or format(s) of the files and/or content provided in the translation request. As provided above, examples of types include code, text, presentations, and images and examples of formats include text, images, presentations, web pages, web browsers, programming languages, and scripting languages. Other examples of formats with format extensions of .txt, .gxp, .html, .xml, and .ppt.

At 207, the control module 33, the preview module 35, the file handling module(s) 36, and/or the normalizing module 110 separates translatable content from non-translatable content. One of the modules 33, 35, 36 may transmit a translatable content signal to the requestor device 12 indicating the content that is translatable and the content which is non-translatable. The translatable content and non-translatable content may be stored separately in the memory 34 and/or a translatable content file generated by one of the modules 33, 35, 36 may be stored in the memory 34. The translatable content file indicates the data (e.g., addresses of the data) that is translatable and/or non-translatable.

At 208, the file type module 72 may transmit the translation request, the data file(s) and/or the translatable content to the preview module 35 or to one or more of the file handling modules 36. If there is more than one file and/or there are more than one file type and/or format, the file type module 72 may divide up the translation request based on the file types and formats. The files may then be transmitted to appropriate one(s) of the file handling modules 36 capable of normalizing the respective files and formats.

At 209, the normalizing module 110 normalizes the translatable content as described above. The normalizing module 110 may normalize the translatable content based on the translatable content file to generate a normalized content file. The normalized content file may include non-translated information. The non-translated information may be used at 233 by the denormalizing module 112 when converting denormalized translated content into an original requestor native format. The normalizing module 110 may remove and/or lock out (disable) the non-translated information from the normalized content file to prevent the selected translators from translating the non-translated information. When removed, the non-translated information may be appended to translated content received from the selected translators at 232 and prior to being denormalized and/or provided to the requestor device 12.

Certain non-translated information may not be visible to the selected translators. For example, if the normalized content file is an HTML file with scripting language (e.g., Javascript) that executes if the normalized content file is loaded, the scripting language is removed or locked out to prevent the selected translators from executing the scripting language. In one implementation, the translatable text within a script of the normalized content file is moved elsewhere in the normalized content file.

Other non-translated information may be visible to the selected translators. In certain situations, the non-translated information is visible to the selected translators and is “locked” from being translated. Examples of non-translatable information that may be visible are inline formatting, images, and/or description added by a content author specifically to provide context for the translators.

As another example, when an HTML file has pull-down menus, scripting language is removed or locked out to improve translation performance. This prevents a translator from accessing each pull-down menu option to find each line of text to be translated. For each page with a pull down menu, the scripting language may be stripped out of the normalized content file and the translatable text in and/or associated with the pull-down menus is moved to the bottom of each page. The scripting language that is removed is later used to reconstruct the pull-down menus in the denormalized content file at 233.

As another example, the normalized content file may not have scripting language, but may have codes or notes (other non-translated information) that are not to be translated or changed, yet may be useful for the selected translators. In that case, the other non-translated information is locked out to prevent editing of this information by the selected translators. An example of a code is a string identifier of or associated with content to be translated.

At 210, the preview module 35, the estimate module 100, the file count module 102 and/or the word count module 104 estimates or determines the number of files, words and/or pages of translatable original language words. At 211, the translator managing module 37 determines available translators capable of performing the requested translation and that satisfy user requirements associated with the translation request. This may be done in response to an RPC from the control module 33, the preview module 35 and/or the WFFM 38. The translator managing module 37 selects translators based on user requirements of the requestor device 12 and associated with the translation request and characteristics of the translators 16. Translators, with characteristics that satisfy the user requirements and are able to schedule and perform the translation such that time requirements are satisfied, are selected as possible translators to include in the availability table 94.

At 212, the estimator module 100, the cost module 106 and/or the time module 107 estimates and/or determines the number of files, the number of words or pages, costs of the translation, and/or the total turnaround time to perform the translation and return translated content back to the requestor device 12. The costs of the translation may include a cost per word or page translated, a cost per file translated, and a total cost of the translation. The information estimated and/or determined at 210 and 212 may be determined for each available translator. The information estimated and/or determined may include language pair(s) identifying the languages involved in the translations, a native language(s) of one or more translator(s), and availabilities of one or more translator(s). This information may be determined by, for example, the preview module 35, the translator managing module 37, the estimator module 100 and/or one of the other modules of the service provider network 14.

At 214, the translator managing module 37 may generate the availability table 94 based on the estimated and determined information at 210 and/or at 212, other translator characteristics, and the user requirements. The translator managing module 37 selects the translators and stores translator IDs and associated characteristics in the memory 34 as the availability table 94. The availability table 94 may include capacities of each of the available translators, number of jobs currently being handled by each of the translators, the turnaround times of each of the available translators, and other translator characteristics disclosed herein. This provides a user with cost, speed, and time information associated with the translation prior to the translation being processed. The availability table 94 may also include an average number of words per day (e.g., 2000 words per day) that a translator can perform. The number of words per day may be estimated based on data received from the translator tools module 114. Turnaround time of a translator may be based on the number of words per day that can be translated.

The list of available translators provided to the requestor device 12 may be prioritized by the translator managing module 37 and based on user requirements and/or user priority requests. For example, the requestor device 12 may request how the list of available translators is sorted and/or prioritized. The requestor device 12 may select and rank translator characteristics and/or provide to the control module 33 or WFFM 38 a criterion by which translator characteristics and/or translators are to be ranked. The criterion may include ranking the translators based on, for example, quality of translations performed by each of the translators, frequency of translations performed by each translator, number of translations performed by each of the translators previously for the requestor device 12, whether or not the translator has previously performed translations for the requestor, and/or other criterion and/or user requirements disclosed herein. The translator managing module 37 may prioritize and list the available translators based on the ranking of translator characteristics and/or the provided criterion.

The control module 33 provides the availability table 94 including one or more translators that are available and capable of performing the translation and their associated characteristics to the requestor network interface 66. A translator may be capable of performing the translation, for example, when the translator can translate the translatable content between the identified languages, satisfy the user requirements, and has the capacity to handle the size of the translatable content.

When more than one of the translators 16 are involved in performing the translations, related estimates and/or translator characteristics may be summed and/or combined to generate a single availability or job summary table for the job. For example, cost estimates for different translations may be summed to provide a total cost to perform the job. This may include combining availability tables from the control modules involved to generate the job summary table. This may be performed by the control module 33, the translator managing module 37, the WFFM 38 or by another module of the service provider network 14.

At 216, the control module 33 transmits a response signal via the first service provider interface 32 to the requestor device 12. The response signal includes the availability table 94 and/or the job summary table. At 218, the request editing module 86 determines whether a user requirement change request is received from the requestor device 12. If a user requirement change request is received, task 220 is performed, otherwise task 222 is performed. At 220, the request editing module 86 updates the user requirements in the memory. At 221, if the content to translate has changed based on the updated user requirements, task 204 may be performed, otherwise task 210 may be performed.

At 222, the request editing module 86 determines whether a translation change request is received from the requestor device 12. If a translation change request is received, task 224 is performed, otherwise task 226 is performed. At 224, the request editing module 86 updates the translation request stored in the memory 34. Task 204 may be performed subsequent to task 224.

At 226, the accept module 88 determines whether an accept signal has not been received for a predetermined period. If an accept signal is not received within the predetermined period, task 238 is performed, otherwise task 227 is performed.

At 227, the accept module 88 determines whether an accept signal is received from the requestor device 12. A user of the requestor device 12 may review the availability table 94 and click on one of the translators listed or select a different translator. The control module 33 may receive an accept signal from the requestor device 12 when the user (or requestor) approves the translation and selects a translator from the availability table 94. With one or two clicks of, for example, a mouse button by the user, a translator may be selected and a translation of the translatable content may be started. The requestor device 12 generates an accept signal when a translator is selected for the translation. The accept signal is transmitted to the control module 33 via the first service provider interface 32. If an accept signal is received, task 228 is performed, otherwise task 238 is performed.

At 228, the accept module 88 or other module of the service provider network 14 transmits a first request to perform the translation, the translatable content and/or the user requirements to the WFFM 38. At 230, the WFFM 38 routes the translatable content and may also route the user requirements to the selected translator(s). Based on the accept signal and/or the first request signal received from the accept module 88, the WFFM 38 may: schedule the translation (or job); assign the translation request to the selected translator; route the normalized content to the selected translator(s) and/or to the translator tools module 114; wait for the translation to be performed; receive translated content from the selected translator(s) and/or the translator tools module(s) of the selected translator(s); and provide the translated content to a designated device, such as the requestor device 12, a memory (e.g., the memory 34) and/or a third party device. The third party device may be selected by the requestor device 12. Some of these tasks are included below as tasks 232 and 234.

At 231, the selected translator(s) perform the requested translation(s) and return the translated content back to the WFFM 38 via the second service provider interface 39. At 232, once the translation is performed, results of the translation (i.e. translated content) may be received at the service provider network 14 and/or the WFFM 38.

At 233, the WFFM 38 and/or the translator managing module 37 may transmit the translated content to the file handling modules 36 to denormalize the translated content recognizable to the requestor device 12. In one implementation, the translated content is returned to the requestor device 12 without denormalizing the translated content, for example, when the translated content is recognizable to the requester device 12.

At 234, the control module 33 forwards the translated and/or denormalized content back to the requestor device 12 and/or the third party device. The technique may end at 242 subsequent to performing task 234.

At 238, the control module 33, the translator managing module 37 and/or the WFFM 38 may update the availability table 94 as described above, as the qualified and available translators may have changed since the availability table 94 was last updated. Task 211 may be performed subsequent to task 238.

The above-described tasks are meant to be illustrative examples; the tasks may be performed sequentially, synchronously, simultaneously, continuously, during overlapping time periods or in a different order depending upon the application. For example, the requestor network may request changes in the translation request and/or in user requirements at any point in the above-described method. As an example, the tasks 218-224 may be performed prior to one of the tasks 204-216.

The translation techniques disclosed herein are streamlined and perform a localized and efficient translation process. The translation techniques minimize and/or eliminate the need for engineer and/or project manager interventions. These disclosed techniques also prevent translators from accidently corrupting content (or code) by normalizing the content to be translated to a format that is recognizable to a translator.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A computer-implemented method, comprising:
receiving, at a server including one or more processors, a translation request from a requestor device, the server being part of a service provider network configured to perform translation services, wherein the translation request includes a file with translatable content; and
in response to receiving the translation request:
determining, at the server, a type and a format of content in the file including the translatable content;
transferring, at the server, the file to a preview module;
selecting, at the server, at least one file handling module from a plurality of file handling modules to normalize the translatable content based on the type and the format and prior to sending the content of the file to the at least one file handling module;
normalizing, at the server, the translatable content via a file handling module to provide formatted words that are in a predetermined format recognizable to each of a plurality of translators;
estimating, at the server, a number of formatted words to be translated and characteristics of each of the plurality of translators based on the formatted words, the estimated characteristics including: (i) a cost to translate the formatted words, and (ii) an amount of time for the formatted words to be translated;
determining, at the server, a group of the plurality of translators that are available and capable of translating the formatted words based on the estimated characteristics;
transmitting, from the server, a response signal to the requestor device, wherein the response signal indicates the number of formatted words to be translated, the estimated characteristics and the group of the plurality of translators;
initiating, at the server, a translation of the words based on an accept signal received from the requestor device indicating a selected translator;
assigning and routing, by the server, the formatted words to be translated to the selected translator;
receiving, at the server, results of the translation from the selected translator at a work flow fulfillment module; and
routing, by the server, the results from the work flow fulfillment module to the requestor device.

2. A computer-implemented method, comprising:
receiving, at a server including one or more processors, a translation request from a requestor device, the server being part of a service provider network configured to perform translation services, wherein the translation request includes a file with translatable content; and
in response to receiving the translation request:
normalizing, at the server, the translatable content, through at least one file handling module, to provide translatable words that are in a predetermined format;
matching, at the server, a number of formatted words to be translated with characteristics of each of a plurality of translators, the characteristics including: (i) a cost to translate the formatted words, (ii) an amount of time for the formatted words to be translated, and (iii) availabilities of one or more of the plurality of translators;
determining, at the server, a first group of the plurality of translators that are available and capable of translating the formatted words based on the characteristics;
transmitting, from the server, a response signal to the requestor device, wherein the response signal indicates the number of formatted words to be translated, the characteristics and the group of the plurality of translators;
selecting, at the server, one of the first group of the translators that are available and capable of translating the formatted words;
initiating, at the server, a translation of the formatted words at the selected translator;
assigning and routing, by the server, the formatted words to be translated to the selected translator via a work flow fulfillment module;
receiving, at the server, results of the translation from the selected translator at the work flow fulfillment module; and
routing, by the server, the results from the work flow fulfillment module to the requestor device.

3. The computer-implemented method of claim 2, further comprising:
via a file type module of the service provider network
determining a type or a format of content in the file including the translatable content, and
selecting the at least one file handling module from a plurality of file handling modules to normalize the translatable content based on the type or the format; and
via each of the plurality of file handling modules receiving respective portions of the translatable content in a plurality of formats, and
normalizing the respective portions of the translatable content into the predetermined format.

4. The computer-implemented method of claim 2, further comprising:
prior to normalizing the translatable content, separating content of the file into non-translatable content and the translatable content; and
indicating to the requestor device the translatable content and the non-translatable content.

5. The computer-implemented method of claim 2, wherein:
the predetermined format is recognizable by a translator tools module of the selected translator;
the translator tools module includes conversion tools to translate the translatable content between different languages; and
the selected translator translates the translatable content via the translator tools module.

6. The computer-implemented method of claim 2, further comprising matching the translation request with each translator of the first group of the plurality of translators by determining whether each translator of the first group of the plurality of translators:
satisfies user requirements of the requestor device;
has capacity available to support the translation request; and
is capable of performing the translation request.

7. The computer-implemented method of claim 2, further comprising:
via the translator managing module, storing an availability table in memory and updating the availability table, wherein
the availability table includes a list of the first group of the plurality of translators and the characteristics, and
the response signal includes the availability table; and
via the service provider network,
storing and periodically updating a translator table including a list of the plurality of translators, and
selecting the first group of the plurality of translators from the plurality of translators based on the translator table.

8. The computer-implemented method of claim 2, further comprising, via the service provider network:
receiving translation requirement updates from the requestor device;
storing the translation requirement updates in memory;
selecting a second group of the plurality of translators based on the translation requirement updates;
generating an availability table including a list of the second group of the plurality of translators; and
transmitting the availability table to the requestor device.

9. The computer-implemented method of claim 2, further comprising, via the service provider network:
ranking the first group of the plurality of translators based on (i) the characteristics, and (ii) user requirements provided by the requestor device; and
generating the response signal based on the ranking of the first group of the plurality of translators.

10. The computer-implemented method of claim 2, further comprising, the service provider network signaling a localization managing device when the translation request cannot be performed, wherein the localization managing device alerts a project manager that a translation cannot be automatically processed based on the signaling generated by the service provider network.

11. A server that is part of a service provider network configured to perform translation services, the server including one or more processors configured to perform operations comprising:
receiving a translation request from a requestor device, wherein the translation request including a file with translatable content; and
in response to receiving the translation request:
normalizing the translatable content, through at least one file handling module, to provide formatted words that are in a predetermined format;
estimating a number of formatted words to be translated and match the formatted words with characteristics of each of a plurality of translators, the characteristics including: (i) a cost to translate the formatted words, and (ii) an amount of time for the formatted words to be translated,
determining a first group of the plurality of translators that are available and capable of translating the formatted words,
transmitting a response signal to the requestor device indicating the number of formatted words to be translated, the characteristics and the first group of the plurality of translators;
(i) selecting one of the first group of the plurality of translators that are available and capable of translating the formatted words, and (ii) initiating a translation of the words at the selected translator;
assigning and routing the words to be translated to the selected translator via a work flow fulfillment module and receiving results of the translation from the selected translator at the work flow fulfillment module; and
routing the results from the work flow fulfillment module to the requestor device.

12. The system of claim 11, further comprising:
a file type module of the service provider network configured to determine a type or a format of content in the file including the translatable content; and
a preview module of the service provider network configured to select the at least one file handling module from a plurality of file handling modules to normalize the translatable content based on the type or the format of the content in the file.

13. The system of claim 12, further comprising the plurality of file handling modules, wherein each of the plurality of file handling modules is configured to:
receive respective portions of the translatable content in a plurality of formats; and
normalize the respective portions of the translatable content into the predetermined format.

14. The system of claim 12, wherein:
one of the preview module and the at least one file handling module is configured to, prior to the translatable content being normalized, separate content of the file into non-translatable content and the translatable content; and
the service provider network is configured to indicate to the requestor device the translatable content and the non-translatable content.

15. The system of claim 12, wherein the translator managing module is configured to match the translation request with each translator of the first group of the plurality of translators by determining whether each translator of the first group of the plurality of translators:
satisfies user requirements of the requestor device;
has capacity available to support the translation request; and
is capable of performing the translation request.

16. The system of claim 12, wherein:
the service provider network is configured to (i) store an availability table in memory, (ii) update the availability table, and (iii) store and periodically update a translator table including a list of the plurality of translators;
the availability table includes a list of the first group of the plurality of translators and the characteristics;
the response signal includes the availability table; and
the service provider network is configured to select the first group of the plurality of translators from the plurality of translators based on the translator table.

17. The system of claim 12, wherein the service provider network is configured to:
receive translation requirement updates from the requestor device;
store the translation requirement updates in memory;
select a second group of the plurality of translators based on the translation requirement updates;
generate an availability table including a list of the second group of the plurality of translators; and
transmit the availability table to the requestor device.

18. The system of claim 12, wherein the service provider network is configured to:
rank the first group of the plurality of translators based on (i) the characteristics, and (ii) at least one of a criterion and user requirements provided by the requestor device; and
generate the response signal based on the ranking of the first group of the plurality of translators.

19. The system of claim 18, wherein the service provider network is configured to signal a localization managing device when the translation request cannot be performed.

20. The system of claim 11, wherein:
the predetermined format is recognizable by a translator tools module; and
the selected translator translates the translatable content via the translator tools module.
